(19) United States
(12) Patent Application Publication
(10) Pub. No.: US 2015/0350352 A1
(43) Pub. Date: Dec. 3, 2015

(54) System and Method for Implementing Device Identification Addresses to Resist Tracking

(71) Applicant: Jonathan J. Valliere, Stuart, FL (US)

(72) Inventor: Jonathan J. Valliere, Stuart, FL (US)

(21) Appl. No.: 14/292,808

(22) Filed: May 30, 2014

(51) Int. Cl. H04L 29/08; H04L 29/12

(52) U.S. Cl. CPC H04L 67/18; H04L 61/2007; H04L 61/6068

(57) ABSTRACT

A system and method for altering a device identification address in response to various criteria to hinder tracking of the device location. One version of the system uses the physical location of the device as a criteria for manipulating the device address in locations that are not recognizable by stored location information and returning the identification address to a preset address in locations that are recognizable. A second version of the invention uses a pair of identification addresses which when recognized together provide a bases for using a given identification address and when not paired together actuates a different identification address to defeat tracking systems.

### AREA OF THE INVENTION

The present invention generally relates to the area of computer-based wireless communications. The invention provides means to communicate with other wireless devices in a way that malicious devices cannot track the device while in range.

### BACKGROUND OF THE INVENTION

Wireless communication devices are everywhere. Today devices such as cell phones, bluetooth accessories, laptops, cellular-wifi access points, and automobiles are connected or have the ability to communicate wirelessly.

By design, wireless communication protocols contain information that is intended to be globally unique in order for a communication to be accepted by a local device. While such protocols are at the foundation of computer communications, they necessarily include device address identifiers that make passive tracking relatively simple, which in turn makes an invasion of user privacy a frightening reality. These address identifiers, regardless of the format they assume, can be readily understood by receptor devices that can not only tell the current location of a device user, but where the user has been in the past, and coupled with other data, where the user lives.

In our rapidly accelerating technological world, individual steps must be taken to keep pace with the tracking of individuals and the resulting loss of privacy and personal security.

### SUMMARY OF THE INVENTION

This invention provides solutions to modify the standard device identification procedures, used in computer networks to resist tracking while maintaining compatibility with existing systems. This invention includes procedures to modify address identifiers including source and destination address pairing and location-based security zones which determine when to implement source address modification. These inventions are designed to provide location privacy for mobile devices.

### BRIEF DESCRIPTION OF THE DRAWINGS

FIG. 1 illustrates a flow-chart for modifying a device identification address when the device location has changed.

FIG. 2 illustrates a flow-chart for modifying a device identification address in accordance with the detection or absence of stored remote and local address pairs.

### DETAILED DESCRIPTION OF THE DRAWINGS

As described herein; a “device identification address”, further referenced as DA, is a numerical string used to identify one communication device from another. This address can be of either physical or logical. In computing, the physical address is commonly implemented as “media access control (MAC)” or as “extended unique identifier (EUI)” addresses. In computing, the logical address is commonly implemented as “internet protocol (IP)” addresses. All networked communication occurs over “media” which consists of wireless and/or wired signals. In computer communications, these addresses are the primary means to identify if a piece of information is meant for one device as opposed to another.

This invention describes a set of procedures for manipulating a DA (or list of DA if supported by the device). The method of setting a DA , itself, is well understood in the “area of the invention”.

As further described herein, these procedures can be used to implement tracking resistant wireless communications.

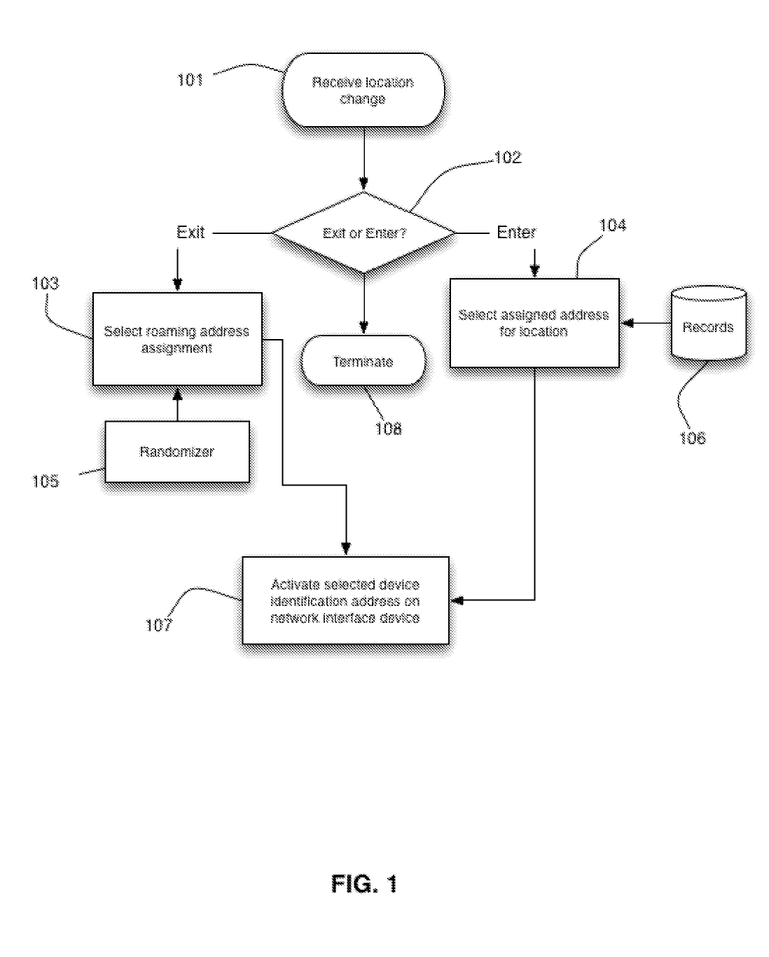

FIG. 1 illustrates a flow-chart to enable tracking protection by modifying a DA when the device location has changed. This is an important scenario because it is useful to disable tracking protection when the device is in a certain physical location, such as work or home.

The workflow in FIG. 1 begins with an abstraction of sensory hardware/software to determine when and how the device is moving as 101. This could be an abstraction of global positioning system (GPS), device accelerometer, wireless device availability, or any other type of location type sensory available to the device. When the sensory trigger occurs in 101, the type of sensory event must be determined in 102. Depending on the event there are three (3) possible actions.

If the sensory event from 101 is determined to represent an “entrance” to a location by 102 then the system proceeds to 104 where the DA for the given location is selected from list 106. The DA is then utilized in 107 to configure the network interface device.

If the sensory event from 101 is determined to represent an “exit” of a location by 102 then the system proceeds to 103 where a new roaming DA is generated by the generating means 105 and utilized in 107 to configure the network interface device.

If the sensory event from 101 is determined to not represent “entrance” or “exit” then no other actions are to be preformed as shown in 108.

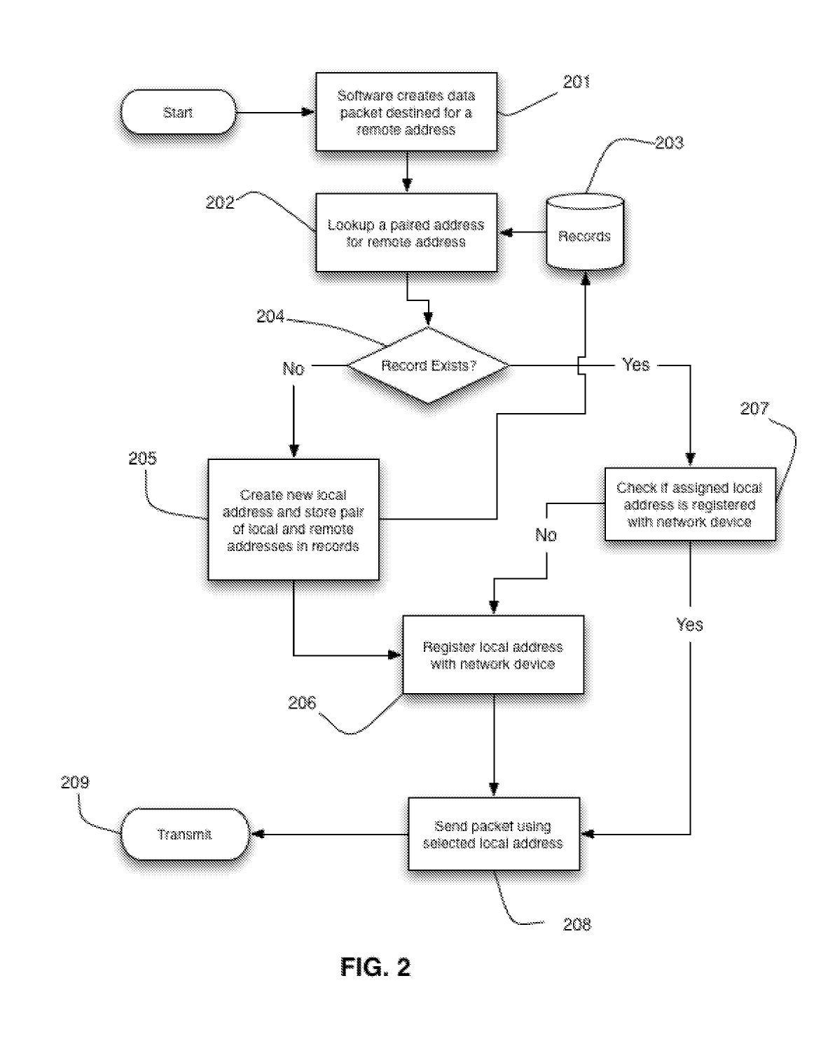

FIG. 2 illustrates a flow-chart wherein modifying a DA does not require any sensory hardware/software. FIG. 2 illustrates a system which utilizes a unique local DA for every remote DA.

When attempting to communicate, the software creates a data packet destined for a remote address 201. At this point the system determines how to identify itself. After the intention to communicate 201; the software looks in a record means 203 to determine if a DA pair exists which includes the DA for the specific remote device to which communication is intended.

If such a DA pair exists in 203 as requested by 202 a decision 204 is made to determine the next action. The local DA of the detected pair is then checked in 207 to see if it currently is registered with the network device. If the local DA is currently so registered then no other action is preformed, and the data packet from 201 is sent to the network device via 208 and then to the media in 209.

If no required DA pair exists in 203 as determined by 204 then the software proceeds to 205 where a new local DA is generated and stored in 203 for use for the next time 201 is invoked. The newly generated local DA, is then registered with the network device via 206. The data packet from 201 is sent to the network device via 208 and then to the media 209.

Optionally, the records in 203 can be extended to provide time to live (TTL) parameters which will cause a pair of DAs to be ineffective after a given amount of time. This could be utilized to provide increased security when visiting the same location on repeated occasions.

What is claimed is:

1. A computing device comprising;
a central processing unit for carrying out the instructions of a computer program,
a primary memory unit for supplying instructions and data to said central processing unit,
a network interface means,
an operating system capable of defining an identification address for said computing device,
location means for receiving information indicative of the physical location of the computing device,
adjusting means responsive to said location means for altering said identification address of said computing device,
and means for coupling the output of said adjusting means to said network interface means,
whereby said network interface means submits an identification address for said computing device that is capable of changing in response to the physical location of said computing device.

2. A computing device in accordance with claim 1, which includes:
means for permanently storing at least one fixed identification address,
means for associating said one fixed identification address with a given location of said computing device,
sensing means for determining when said computing device is within said given location, and
means responsive to said sensing means to send said one fixed identification address to said network interface means,
whereby said computing device is caused to submit said one fixed identification address when said computing device is within said given location.

3. A computing device in accordance with claim 2 which includes:
identification address generating means having an output capable of creating multiple identification addresses,
means for configuring said network interface means utilizing the output of said identification address generating means when said computing device is not within said given location,
whereby said computing device is cause to submit said one fixed identification address when said computing device is within said given location and to submit multiple identification addresses when said computing device is not within said given location.

4. A computing device in accordance with claim 3 wherein said identification address generating means comprises:
an address randomizer for generating identification addresses at random and a means for selecting an address from said address randomizer and submitting said selected address to said network interface means.

5. A computing device in accordance with claim 3 wherein said sensing means comprises a filtering means that determines when said computing device is moved from a point outside said given location to a point inside said given location and thereupon to configure said network interface means to utilize said fixed identification address and to determine when said computing device is moved from a point inside said given location to a point outside said given location and thereupon to configure said network interface means to utilize an identification address derived from said identification address generating means,
whereby the movement of said computing device into said given location results in the configuration of the network interface means with the fixed identification address associated with said given location, and the movement of said computing device out of said given location results in the configuration of said network interface means with one of a multiple of identification addresses.

6. A computing device in accordance with claim 5 wherein said identification address generating means comprises:
an address randomizer for generating identification addresses at random and a means for selecting an address from said address randomizer and submitting said selected address to said network interface means.

7. A computing device comprising;
a central processing unit for carrying out the instructions of a computer program,
a primary memory unit for supplying instructions and data to said central processing unit,
a network interface means for communicating with a device having a remote identification address,
an operating system capable of defining an identification address for said computing device,
storage means for storing at least one pair of identification addresses, one of said pair being a local address associated with said computing device and the other of said pair being associated with a remote device,
means for selecting a given remote identification address,
look up means to determine if the given remote identification address is one address of a pair of addresses stored in said storage means,
switching means having a first output activated by a determination of the look up means that an address pair exists in said storage means that is associated with the given remote identification address and having a second output activated by a determination of said look up means that such an address pair does not exists in said storage means,
means for configuring said network interface means with the local address when said first output of said switching means is activated,
an identification address generating means for generating multiple identification addresses,
means for configuring said network interface means with an output of said identification generating means when said second output of said switching means is activated, and
whereby said network interface means is configured with an identification address for said computing device that is derived from a stored pair of addresses in the case where a stored pair is recognized by said look up means and configured with an identification address derived from said identification address generating means in the case that said look up means fails to locate a stored pair associated with a targeted remote address.

8. A computing device comprising;
a central processing unit for carrying out the instructions of a computer program,
a primary memory unit for supplying instructions and data to said central processing unit,
a network interface means for communicating with a remote device having a remote identification address,
an operating system capable of defining a local identification address for said computing device,
a storage means for storing and retrieving a pair of identification addresses where one address of said pair represents a remote device and the other address of said pair represents the local address said computing device utilizes when communicating with said remote device,
means for configuring said network interface means with said stored local identification address at times when said computing device is attempting to communicate with said remote device,
whereby said computing device is caused to have a local address as defined by a pair in said storage means.

9. A computing device in accordance with claim 8 including:
means for generating and selecting a new random local identification address and configuring said network interface means with said new address when said computing device is attempting to communicate with a remote device having an identification address not found in said storage means,
whereby said computing device is caused to have a local identification address that changes upon attempting to communicate with a remote device having an identification address not found in said storage means.

10. A computing device in accordance with claim 9 including:
means for recording in said storage means said new random local identification address as a pair with the identification address of said remote device,
whereby said storage means is supplemented with a new pair of identification addresses.

11. A computing device comprising;
a central processing unit for carrying out the instructions of a computer program,
a primary memory unit for supplying instructions and data to said central processing unit,
a network interface means,
an operating system capable of defining an identification address for said computing device,
means for automatically configuring said network interface means with an assigned local identification address under conditions wherein an assigned local identification address is desirable, and means for automatically configuring said network interface means with a local identification address that is different from said assigned local identification address when the use of said assigned address is undesirable,
whereby the tracking of said computing device by the tracking of its identification address is inhibited.

12. A computing device in accordance with claim 11 wherein:
said means for automatically configuring said network interface means with an assigned local identification address under conditions where an assigned local identification address is desirable includes determining means for determining if said assigned local identification address is one of a pair of identification addresses stored in said computing device,
and if it be so determine to configure said network interface means with said assigned local identification address.

13. A computing device in accordance with claim 11 wherein:
said means for automatically configuring said network interface means with an assigned local identification address under conditions where an assigned local identification address is desirable
includes means for sensing the physical location of said computing device
and means for configuring said network interface means with said assigned local identification address when said computing device is physically located within a predetermined physical location.

14. A computing device in accordance with claim 12 which includes:
means for generating a new local identification address when said determining means determines that said assigned local identification address is not one of a pair of identification addresses stored in said computing device,
and means for configuring said network interface means with said new local identification address.

15. A computing device in accordance with claim 13 which includes:
means for randomly selecting a local identification address when said computing device is not within a predetermined physical location
and means for configuring said network interface means with said randomly selected local identification address,
whereby tracking of said computing device is inhibited.

16. A computing device in accordance with claim 14 which includes:
means for storing pairs of identification addresses where one of each pair is a local identification address and the other of said pair is a remote identification address.

17. A computing device in accordance with claim 15 which includes:
means for storing indicia of a predetermined physical location
and means for determining if said computing device is at an instant of time physically located within the physical location boundaries determined by said indicia,
and in the case where it be so determined, means for configuring said network interface means with said assigned local identification address,
whereby tracking of said computing device is inhibited.

18. A method of inhibiting tracking of a computer device having an interface means comprising the steps of:
determining a first criteria for enabling said interface means with an identification address,
determining a second criteria for enabling said interface means with an identification address,
creating a first identifying address for said computing device,
creating a second identifying address for said computing device which is different from said first identifying address,
means for configuring said interface means with said first identifying address using said first criteria, and
means for configuring said interface means with said second identifying address using said second criteria,
Whereby said computing device is caused to have a variable identifying address to thereby inhibit tracking of said device.

19. A method as described in claim 18 which includes the step of monitoring the physical location of said computing device, and
wherein said first criteria is information pertaining to a predetermined physical location of said computing device, and
wherein said second criteria is information pertaining to a location of said computing device which is different from said predetermined location,
whereby said computing device is caused to have an identifying address that is variable and dependent on the physical location of said device.

20. A method as described in claim 18 which includes the step of creating at least one pair of identifying addresses,
wherein said first criteria is information that said computing device is attempting to communicate with a remote device having an identifying address corresponding to one of said pair of identifying addresses, and
wherein said second criteria is information that said computing device is attempting to communicate with a remote device having an identifying address which does not correspond one of said pair of identifying addresses,
whereby said computing device is caused to have a variable identification address depending on the remote device to which communication by said computing device is being attempted.
